(19) United States
(12) Patent Application Publication
(10) Pub. No.: US 2002/0022389 A1
(43) Pub. Date: Feb. 21, 2002

(54) Conductor

(76) Inventors: Takeshi Hikata, Itami-shi (JP); Nobuyuki Okuda, Itami-shi (JP); Koichi Sogabe, Itami-shi (JP); Shosaku Yamanaka, Itami-shi (JP)

Correspondence Address: FASSE PATENT ATTORNEYS, P.A., P.O. BOX 726, HAMPDEN, ME, 04444-0726, US

(21) Appl. No.: 09/904,293

(22) Filed: Jul. 12, 2001

(30) Foreign Application Priority Data
Jul. 13, 2000 (JP) 2000-212617(P)

(51) Int. Cl. H01R 4/58

(52) U.S. Cl. 439/86

(57) ABSTRACT

A conductor of the present invention has a conductive DLC film formed on a conductive base. A conductive DLC film is formed on a conductive base and is supported by a conical spring electrode to be in contact with the conductive DLC film. Thus, a conductor is obtained which has good wear resistance and oxidation resistance and which is suitable for bringing conductive parts into contact.

### BACKGROUND OF THE INVENTION

1. Field of the Invention

The present invention relates to conductors and, more specifically to a conductor having a plurality of conductive parts which are brought into contact for electrical connection.

2. Description of the Background Art

Conventional examples of contact portions of conductive parts which are brought into contact for electrical connection include a usual metal, organic conductive material such as carbon, and noble metal material.

However, the usual metal tends to be oxidized and become insulative. In addition, the metal tends to wear because of its poor strength, and the useful life thereof is short.

Similarly, the organic conductive material also tends to wear because of its poor strength, and the useful life thereof is short.

The noble metal material has been used as a conductive material having resistance to oxidation. However, it tends to wear because of its poor strength. As such, the noble metal material has a short useful life and is expensive.

### SUMMARY OF THE INVENTION

An object of the present invention is to provide a conductor which has good wear resistance and oxidation resistance and which easily allows conductive parts to be brought into contact.

A conductor of the present invention refers to a conductor having a plurality of conductive parts which becomes conductive when the a plurality of conductive parts are brought into contact. At least one conductive part of the plurality of conductive parts has a film containing conductive hard carbon at a contact portion with respect to another conductive part.

According to the conductor of the present invention, the conductive hard carbon is contained at the contact portion of the conductive parts. Thus, the contact portion has enhanced oxidation resistance, strength, and hence wear resistance. Accordingly, even if the number (or time) of contacts between the conductive parts increase, degradation of the contact portion is suppressed to provide a longer useful life.

In the above mentioned conductor, preferably, the film containing the conductive hard carbon has a resistivity of at least 5×10⁻⁵ Ωcm and at most 10 Ωcm.

Thus, the contact portion has a low contact resistance.

Preferably, the above mentioned conductor switches between electrically connected and disconnected states as the states in which the plurality of conductive parts are in contact and out of contact are switched.

Thus, the conductor for an electrical contact with excellent wear resistance and oxidation resistance can be provided.

In the above mentioned conductor, preferably, the contact portion of at least one of the plurality of conductive parts and another conductive part slides or opens/closes.

Because the contact portion is adapted to slide or open/close, the contact portion with excellent wear resistance and oxidation resistance that can slide or open/close can be provided.

In the above mentioned conductor, preferably, the film containing conductive hard carbon is formed by vapor deposition.

Thus, the film containing conductive hard carbon can be readily formed by vapor phase epitaxy such as CVD (Chemical Vapor Deposition) or PVD (Physical Vapor Deposition).

In the above mentioned conductor, preferably, the film containing conductive hard carbon includes a conductive material having a resistivity lower than that of the conductive hard carbon.

Thus, the conductive material can provide a higher conductivity while ensuring hardness by the conductive hard cover. In addition, since the conductive hard carbon and the conductive material can be formed simultaneously, a manufacturing process would not become complicated.

In the above mentioned conductor, preferably, the conductive materials are distributed in the film containing conductive hard carbon in the thickness direction of the film containing conductive bard carbon.

An electrical path in the conductive hard carbon that has a relatively high resistivity can be reduced in length, whereby the conductive part is provided with a higher conductivity.

In the above mentioned conductor, preferably, the conductive hard carbon is provided in the thickness direction of the film containing conductive hard carbon from the upper surface to lower surface of the film.

Thus, the film containing conductive hard carbon can be provided with a higher conductivity and good adhesion in the thickness direction.

In the above mentioned conductor, preferably, the film containing conductive hard carbon is formed at any of a key contact, plug contact, printed circuit board contact, and sliding contact.

Being formed at any of these contacts, the film can suppress degradation of the contact.

In the above mentioned conductor, preferably, the film containing conductive hard carbon is formed on a surface of a linear element.

Thus, a bristle with good wear resistance can be provided.

In the above mentioned conductor, preferably, the linear element having the film containing the conductive hard carbon on its surface is contained in a base including a metal or carbon.

Thus, a sliding electrode material with good wear resistance can be provided.

In the above mentioned conductor, preferably, the films containing conductive hard carbon are formed on the surfaces of conductive fibers, which are woven.

Thus, a contact can be formed with an elastic and highly durable spring member.

In the above mentioned conductor, preferably, the film containing conductive hard carbon is formed on a surface of at least one of a conductive fiber cloth and elastic material.

Thus, the underlying conductive fiber cloth and elastic material facilitates soldering or welding, and the film containing conductive hard carbon of the upper layer can provide a spring member with good wear resistance.

In the above mentioned conductor, preferably, the films containing conductive hard carbon are formed on surfaces of the conductive bristles, which are bundled in a brush-like form.

Since the electricity supplying member in the brush-like form has good wear resistance, the conductive part has a longer useful life.

In the above mentioned conductor, preferably, the linear element or conductive fiber includes carbon fiber or metal.

Since the base material includes carbon fiber or metal, it can be contained in various types of materials.

In the above mentioned conductor, preferably, the conductive hard carbon includes at least one of diamond like carbon (DLC), amorphous carbon (a-C), and conductive diamond.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view schematically showing the structure of a conductor according to a first embodiment of the present invention.

FIG. 2 is a cross sectional view schematically showing the structure of a conductor according to a second embodiment of the present invention,

FIG. 3 is a schematic cross sectional view taken along the line III-III in FIG. 2.

FIG. 4 is a schematic cross sectional view taken along the line IV-IV in FIG. 2.

FIG. 5 a cross sectional view schematically showing the structure of a conductor according to a third embodiment of the present invention.

FIG. 6A and FIG. 6B are schematic cross sectional views partially showing a conductor according to a fourth embodiment of the present invention.

FIG. 7 is a cross sectional view schematically showing the structure of a conductive DLC coat fiber of FIGS. 6A and 6B.

FIGS. 8A and 8B are schematic cross sectional views partially showing a conductor according to a fifth embodiment of the present invention.

FIGS. 9A and 9B are schematic cross sectional views partially showing a conductor according to a sixth embodiment of the present invention.

FIG. 10 is a schematic cross sectional view showing conductive materials stretching in the thickness direction according to a seventh embodiment of the present invention.

FIG. 11 is a cross sectional view schematically showing that the conductive materials and conductive DLC are connected in the thickness direction of the film from the upper to lower surface of the film according to the seventh embodiment of the present invention

FIG. 12 is a schematic cross sectional view shown in conjunction with an intermediate layer.

### DESCRIPTION OF THE PREFERRED EMBODIMENTS

Now, embodiments of the present invention will be described.

### First Embodiment

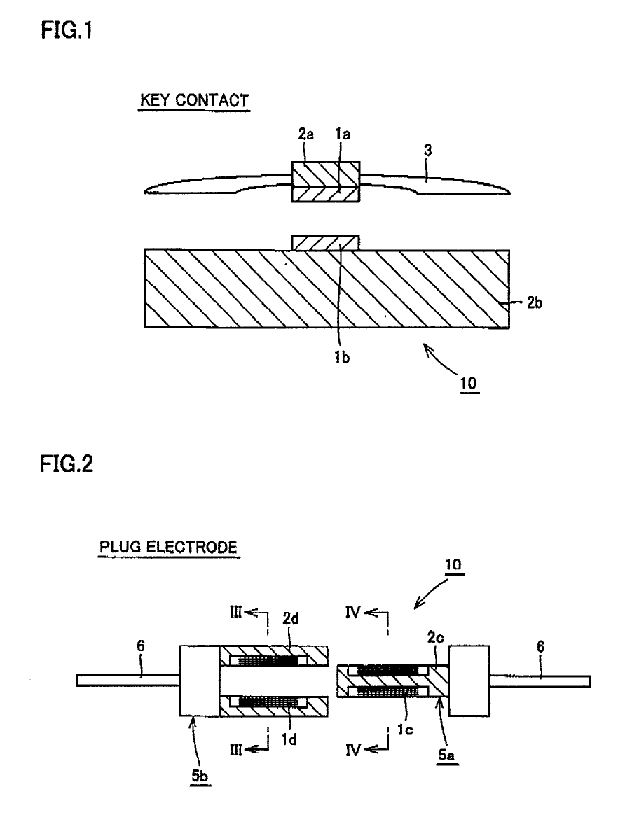

Referring to FIG. 1, a conductor 10 of the present embodiment forms a key contact, having conductive DLC films 1a, 1b, conductive bases 2a, 2b, and a conical spring electrode 3. Conductive DLC film 1b is formed on conductive base 2b. Conductive DLC film 1a is formed on conductive base 2a and supported by conical spring electrode 3 to be brought into contact with conductive DLC film 1b. Note that conductive bases 2a, 2b are formed of a metal such as copper.

When a button such as a ten key and function key is pressed, conical spring electrode 3 is deflexed. Thus, conductive DLC film 1a is brought into contact with conductive DLC film 1b for electrical connection, or conductive DLC film 1a is brought out of contact with conductive DLC film 1b for electrical disconnection. In this way, the states of electrical connection and disconnection are switched.

In the present embodiment, since the contact portion has a hard carbon film such as conductive DLC films 1a, 1b, the contact portion has enhanced oxidation resistance, strength, and hence wear resistance. Thus, even if the connecting number (or time) of the conductive parts increases, degradation of the contact portion is suppressed to provide a longer useful life.

### Second Embodiment

Referring to FIG. 2, a conductor 10 of the present embodiment forms a plug contact, having elastic fiber woven cloths 1c, 1d covered by a conductive DLC, conductive bases 2c, 2d, and cables 6a. 6b.

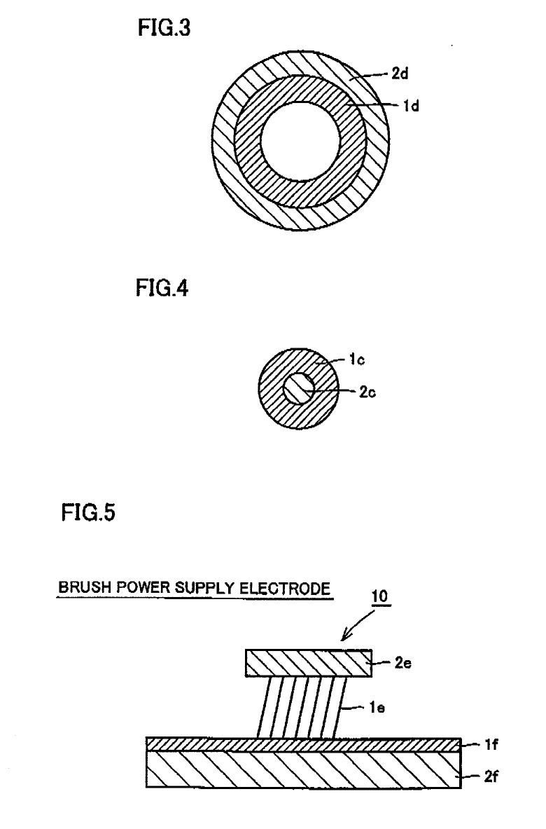

Elastic fiber woven cloth 1d covered by the conductive DLC is connected to the inner surface of conductive base 2d of a receiving plug 5b for example by welding as shown in FIG. 3. Elastic fiber woven cloth 1d is designed such that a metal fiber is positioned on the surface facing conductive base 2d and the conductive DLC is positioned at the contact.

Elastic fiber woven cloth 1c covered by the conductive DLC is connected to the outer surface of conductor base 2c of plug 5a for example by welding as shown in FIG. 4. Elastic fiber woven cloth 1c is designed such that the metal fiber is positioned on the surface in contact with conductive base 2c, and the conductive DLC is positioned at the contact.

Note that each of conductive bases 2c, 2d is electrically connected to cable 6.

By inserting and extracting plug 5a to and from receiving plug 5b, elastic fiber woven cloths 1c, 1d, covered by the conductive DLC, are brought into contact to provide electrical connection or brought out of contact to provide electrical disconnection. Thus, the states of electrical connection and disconnection can be switched.

In the present embodiment, a hard carbon film such as a conductive DLC film is formed at the contact portion. Thus, the contact portion has enhanced oxidation resistance, strength, and hence wear resistance. Accordingly, even if the number of contacts (or time) of the conductive parts increases, degradation and the contact portion is suppressed to provide a longer useful life.

Since elastic fiber woven cloths 1c, 1d covered by the conductive DLC is used for the contact portion, the fiber cloths facilitate soldering or welding with respect to conductive bases 2c, 2d. In addition, a spring member with good wear resistance can be provided by the film containing the conductive hard carbon.

### Third Embodiment

Referring to FIG. 5, a conductor 10 of the present embodiment forms a sliding contact with use of a brush power supply electrode, having an elastic bristle 1e covered by the conductive DLC, a conductive boron-doped diamond film 1f, and conductive bases 2e, 2f.

Elastic bristles 1e each covered by the conductive DLC are bundled together in a brush-like shape and supported by conductive base 2e. Conductive diamond film 1f is formed on conductive base 2f.

Movement (e.g., rotation) of one of the above mentioned conductive bases 2e and 2f causes elastic bristle 1e covered by the conductive DLC to slide over conductive diamond film 1f. Thus, electrical connection of 1e and 1f is maintained.

In the present embodiment, since a hard carbon film such as a conductive DLC film or conductive diamond film is formed at the contact portion, the contact portion has enhanced oxidation resistance, strength, and hence wear resistance. As a result, if the sliding time of the conductive parts increases, degradation of the contact is suppressed to provide a longer useful life. In addition, if a material which has less wear resistance is selected for the brush side of both surfaces of the contact, the useful life can be further prolonged.

### Fourth Embodiment

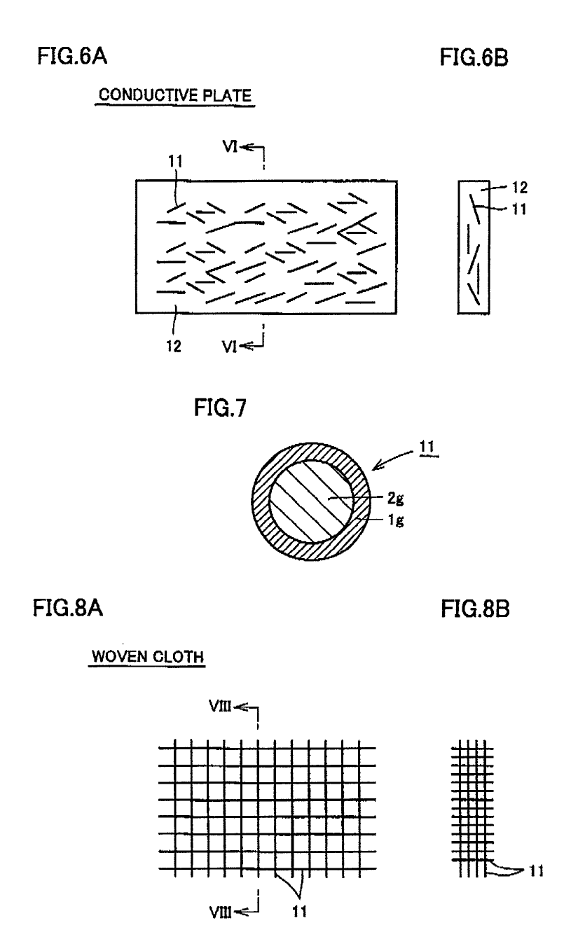

For each contact of the above described first to third embodiments, a conductive base 12 containing conductive DLC coat fibers 11 as shown in FIGS. 6A and 6B may be used.

Conductive DLC coat fiber 11 has conductive fiber 2g of carbon fiber, metal (such as copper) or the like, which is covered by conductive DLC film 1g. Conductive base 12 is formed of carbon fiber, metal (such as copper) or the like.

Note that FIG. 6B is a cross sectional view taken along the line VI-VI of FIG. 6A.

### Fifth Embodiment

For each of the contacts according to the above described first to third embodiments, a woven cloth with woven conductive DLC coat fibers 11 as shown in FIGS. 8A and 8B may be used. Conductive DLC coat fibers 11 each has a structure as shown in FIG. 7.

Note that FIG. 8B is a cross sectional view taken along the line VIII-VIII of FIG. 8A.

Thus, a contact portion of a spring member with elasticity and durability can be provided.

### Sixth Embodiment

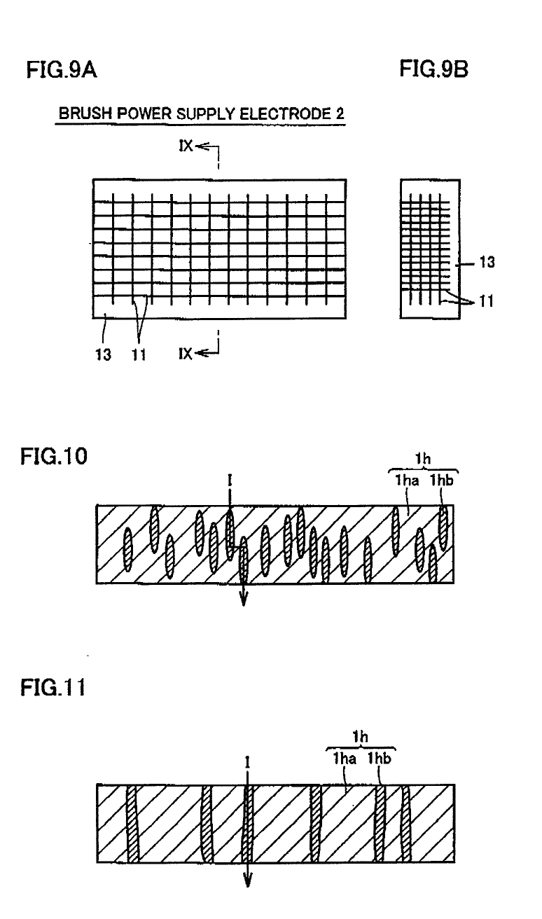

For each of the contact according to the above described first to third embodiments, a woven cloth may be used having woven conductive DLC coat fibers 11 shown in FIGS. 8A and 8B which is impregnated with a thermosetting resin 13 as shown in FIGS. 9A and 9B and then subjected to carbonization.

Note that FIG. 9B is a cross sectional view taken along the line IX-IX of FIG. 9A.

### Seventh Embodiment

For each of the contacts according to the above described first to third embodiments, a film may be used having a conductive part with a resistivity that is lower than that of conductive hard carbon (DLC, a-C) and having the above described conductive hard carbon, which are simultaneously formed.

Thus, a greater conductivity is provided by the conductive material while maintaining hardness by the conductive hard carbon. In addition, since the conductive hard carbon and conductive part are simultaneously formed, the process would not become complicated.

In this case, it is preferable that the film has conductive parts hb with low resistivity that are distributed in conductive hard carbon 1ha in the thickness direction of film 1h as shown in FIG. 10. Thus, since a current flows through path I, for example, conductive hard carbon 1ha with relatively high conductivity can be reduced in length, whereby a greater conductivity is provided.

Further, preferably, conductive part 1hb and conductive hard carbon 1ha are connected in the thickness direction of film 1h from the upper to lower surface as shown in FIG. 11. This gives a higher conductivity to film 1h and good adhesion is obtained in the thickness direction.

Note that, in the above described first to seventh embodiments, the contact portion is not limited to the film containing the conductive DLC. Alternatively, a film containing conductive a-C may be used, and any film that contains the conductive hard carbon may be employed.

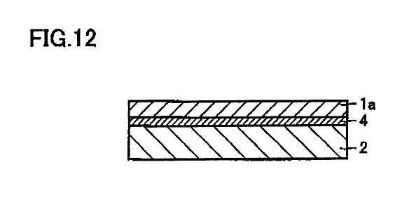

In the above described first to seventh embodiments, a conductive intermediate layer 4 may be provided between film 1 containing the conductive DLC and conductive base 2 as shown in FIG. 12. This provides improved adhesion between film 1 containing the conductive DLC and conductive base 2.

Preferably, in the above described first to seventh embodiments, the film containing the conductive hard carbon has a resistivity of at least 5×10⁻⁵ Ω and at most 10 Ωcm. Thus, the contact portion has a lower contact resistance.

In addition, the film containing the conductive hard carbon can be readily formed by vapor phase epitaxy such as CVD or PVD.

Now, experimental examples of the present invention will be described.

### Experimental Example 1

Six types of conductive DLC films as shown in the following Table 1 were formed on copper substrates of a conical spring and a receiving side contact that form a key contact for a portable telephone. For comparison, a contact without a conductive DLC was prepared. After performing ten thousand contact operations, the contact resistance at the key contact was measured. The results are also shown in the following Table 1.

TABLE 1

| | | |
|---|---|---|
| | | Key contact performance |
| | | after connecting 10 thousand |
| | | times (contact resistance) |
| | | ⊚ excellent (not greater |
| | | than twice the original |
| | | value) |
| Intermediate layer | DLC film | ∘ good |

| Sample | | Thickness | | Co-molded | Thickness | | Hardness | Resistivity | X bad (greater than ten |
|---|---|---|---|---|---|---|---|---|---|
| number | Material | (μm) | Method | material | (μm) | Method | (GPa) | (Ωcm) | times the original value) |
| 1 | — | — | — | — | 1.4 | arc | 23 | 2 × 10⁻² | ∘ |
| 2 | — | — | — | Cr | 1.0 | sputter | 21 | 4 × 10⁻⁴ | ⊚ |
| 3 | — | — | — | Silver | 0.5 | arc | 7 | 1 × 10⁻⁴ | ⊚ |
| 4 | TiN | 0.5 | hole | Ti | 0.5 | hole | 17 | 3 × 10⁻⁴ | ⊚ |
| | | | cathode | | | cathode | | | |
| 5 | — | — | — | Boron | 1.0 | plasma | 21 | 5 × 10⁻³ | ⊚ |
| | | | | | | CVD | | | |
| 6 | — | — | — | Copper | 2.0 | sputter | 10 | 3 × 10⁻⁵ | ⊚ |
| Comparative | none | none | none | none | none | none | none | 4 × 10⁻⁴ | X |
| example | | | | | | | | | |

Table 1 shows that the contact with a DLC film did not experience any change in properties such as oxidation, exhibiting good contact performance. On the other hand, the contact not with a DLC film had extremely high contact resistance after connecting operations,

### Experimental Example 2

Conductive DLC films were formed on carbon fibers to have a thickness of about 0.3 μm. An electrode with these short fibers connected by a thermosetting resin is set as a brush electrode for a motor. In addition, a motor having a rectifier which is different only in the materials of the electrode and brush (namely, a rectifier having an electrode brush of a general carbon and not provided with a conductive DLC film) was manufactured. These motors were subjected to a rotation test.

The result of the rotation test showed that the DC motor with the conductive DLC could continuously rotate for at least ten hours, but a general DC motor could rotate no more than three hours because of brush wearing.

### Experimental Example 3

A bristle was manufactured by simultaneously forming a conductive DLC and copper on a stainless fine wire, which has a diameter of 50 μm and which has been copper-plated, to have a thickness of about 0.5 μm. Further, an elastic cloth-like plate material was formed in the thickness direction by weaving the resultant bristles. A connector obtained by simultaneously forming films of Cr and conductive DLC on the surfaces of the contact was prepared, and the above mentioned cloth-like elastic conductor was inserted to the inner contact portion of the receiving connector. As a result, even after repeatedly inserting and extracting the connector, the inserted cloth-like elastic conductor functioned as a spring part, thereby ensuring stable contact and good contact resistance.

On the other hand, as a comparison example, a connector having the same structure but copper-plated was prepared. A plate obtained by copper-plating and corrugating a stainless was inserted between the contacts of the connector.

As a result, the contact resistance of the comparative example was no more than 50% of the original value after 1,000 insertion/extraction operations, whereas the connector with the conductive DLC of the present invention maintained 95% of the original value even after 1,000 insertion/extraction operations.

As in the foregoing, according to the conductor of the present invention, since the contact of the conductive parts contains conductive hard carbon, the contact is provided with enhanced oxidation resistance, strength, and hence wear resistance. Thus, even if the number of contacts of the conductive parts (or time) increases, degradation of the contact is suppressed to provide a longer useful life.

Although the present invention has been described and illustrated in detail, it is clearly understood that the same is by way of illustration and example only and is not to be taken by way of imitation, the spirit and scope of the present invention being limited only by the terms of the appended claims.

What is claimed is:

1. A conductor having a plurality of conductive parts and rendered conductive when said plurality of conductive parts are brought into contact, wherein at least one conductive part of said plurality of conductive parts has a film containing conductive hard carbon at a contact portion with respect to another conductive part.

2. The conductor according to claim 1, wherein said film containing the conductive hard carbon has a resistivity of at least 5×10⁻⁵ Ωcm and at most 10 Ωcm.

3. The conductor according to claim 1, wherein said conductor is adapted to switch between electrically connected and disconnected states as said plurality of conductive parts are switched between contact and non-contact states.

4. The conductor according to claim 1, wherein a contact portion of at least one conductive part of said plurality of conductive parts and said another conductive part slides or opens/closes.

5. The conductor according to claim 1, wherein said film containing the conductive hard carbon is formed by vapor deposition.

6. The conductor according to claim 1, wherein said film containing the conductive hard carbon includes a conductive material having a resistivity lower than that of said conductive hard carbon.

7. The conductor according to claim 6, wherein said conductive materials are distributed in said film containing the conductive hard carbon as being stretched in a thickness direction of said film containing the conductive hard carbon.

8. The conductor according to claim 7, wherein said conductive hard carbon is continuously provided in said film containing the conductive hard carbon from an upper surface to lower surface in the thickness direction.

9. The conductor according to claim 1, wherein said film containing the conductive hard carbon is formed at any of a key contact, plug contact, printed circuit board contact, and sliding contact.

10. The conductor according to claim 1, wherein said film containing the conductive hard carbon is formed on a surface of a linear element.

11. The conductor according to claim 10, wherein said linear element formed on its surface said film containing the conductive hard carbon is provided in a base including a metal or carbon.

12. The conductor according to claim 1, wherein said film containing the conductive hard carbon is formed on surfaces of conductive fibers, and said conductive fibers are woven.

13. The conductor according to claim 1, wherein said film containing the conductive hard carbon is formed on a surface of at least one of a conductive fiber woven cloth and elastic material.

14. The conductor according to claim 1, wherein said film containing the conductive hard carbon is formed on surfaces of conductive bristles, and said conductive bristles are bundled in a brush-like shape.

15. The conductor according to claim 10; wherein said linear element includes a carbon fiber or metal.

16. The conductor according to claim 12, wherein said conductive fiber includes a carbon fiber or metal.

17. The conductor according to claim 1, wherein said conductive hard carbon has at least one of a diamond like carbon (DLC), amorphous carbon, and conductive diamond.
